(19) United States
(12) Patent Application Publication
(10) Pub. No.: US 2026/0292163 A1
(43) Pub. Date: Sep. 24, 2026

(54) ADAPTIVE LOOP FILTER FOR VIDEO CODING

(71) Applicant: BEIJING DAJIA INTERNET INFORMATION TECHNOLOGY CO., LTD., Beijing (CN)

(72) Inventors: Che-Wei KUO, San Diego, CA (US); Xiaoyu XIU, San Diego, CA (US); Wei CHEN, San Diego, CA (US); Hong-Jheng JHU, San Diego, CA (US); Ning YAN, San Diego, CA (US); Changyue MA, San Diego, CA (US); Xianglin WANG, San Diego, CA (US); Qi HUANG, Beijing (CN); Bing YU, Beijing (CN)

(73) Assignee: BEIJING DAJIA INTERNET INFORMATION TECHNOLOGY CO., LTD., Beijing (CN)

(21) Appl. No.: 19/663,265

(22) Filed: Apr. 30, 2026

Related U.S. Application Data
(63) Continuation of application No. PCT/US2024/053396, filed on Oct. 29, 2024.
(60) Provisional application No. 63/546,502, filed on Oct. 30, 2023.

(51) Int. Cl. H04N 19/117; H04N 19/132; H04N 19/176; H04N 19/186; H04N 19/70; H04N 19/80

(52) U.S. Cl. CPC H04N 19/117; H04N 19/132; H04N 19/176; H04N 19/186; H04N 19/70; H04N 19/80

(57) ABSTRACT

Methods for video decoding and encoding, apparatuses and non-transitory computer-readable storage media thereof are provided. One method for video decoding includes: receiving, by a decoder, a first syntax element representing an adaptive loop filter (ALF) coefficient; receiving, by the decoder and in response to the ALF coefficient being non-zero, a second syntax element indicating a clipping range of ALF input samples; and filtering, by the decoder, a reconstructed video block corresponding to a current block, based on the first syntax element and the second syntax element.

### CROSS-REFERENCE TO RELATED APPLICATIONS

The present application is a continuation application of PCT International Application No. PCT/US2024/053396, filed on Oct. 29, 2024, which is based upon and claims priority to U.S. Provisional Application No. 63/546,502, entitled “Adaptive Loop Filter for Video Coding,” filed on Oct. 30, 2023, the entirety of both of which are incorporated by reference for all purposes.

### TECHNICAL FIELD

The present disclosure is related to video coding and compression. More specifically, this application relates to methods and apparatus on improving the coding efficiency of adaptive loop filter (ALF) and cross-component adaptive loop filter (CCALF).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Embodiments of the present disclosure provide methods and apparatus on improving the coding efficiency of adaptive loop filter (ALF) and cross-component adaptive loop filter (CCALF).

According to a first aspect of the present disclosure, there is provided a method of video decoding, including: receiving, by a decoder, a first syntax element representing an adaptive loop filter (ALF) coefficient; receiving, by the decoder and in response to the ALF coefficient being non-zero, a second syntax element indicating a clipping range of ALF input samples; and filtering, by the decoder, a reconstructed video block corresponding to a current block, based on the first syntax element and the second syntax element.

According to a second aspect of the present disclosure, there is provided a method of video encoding, including: signaling, by an encoder, a first syntax element representing an adaptive loop filter (ALF) coefficient; signaling, by the encoder and under condition that the ALF coefficient is non-zero, a second syntax element indicating a clipping range of ALF input samples; filtering, by the encoder, a reconstructed video block corresponding to a current block, based on the first syntax element and the second syntax element; and generating, by the encoder, a bitstream based on a result of filtering the reconstructed video block.

According to a third aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the first aspect.

According to a fourth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the second aspect.

According to a fifth aspect of the present disclosure, there is provided a non-transitory computer-readable storage medium for storing computer-executable instructions that, when executed by one or more computer processors, cause the one or more computer processors to perform the method according to the first aspect.

According to a sixth aspect of the present disclosure, there is provided a non-transitory computer-readable storage medium for storing computer-executable instructions that, when executed by one or more computer processors, cause the one or more computer processors to perform the method according to the second aspect.

According to a seventh aspect of the present disclosure, there is provided a non-transitory computer-readable storage medium for storing a bitstream to be decoded by the method according to the first aspect.

According to an eighth aspect of the present disclosure, there is provided a non-transitory computer-readable storage medium for storing a bitstream generated by the method according to the second aspect.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5 is a block diagram illustrating an exemplary video encoder in accordance with some embodiments of the present disclosure.

FIG. 6 is a block diagram illustrating an exemplary video decoder in accordance with some embodiments of the present disclosure.

FIG. 7 is an illustration of ALF filter shapes in accordance with some examples of the present disclosure.

FIG. 8 is a depiction of subsampled sample gradients in accordance with some examples of the present disclosure.

FIG. 9 is an illustration of a geometric transformation of a diamond filter shape in accordance with some examples of the present disclosure.

FIG. 10 is an illustration of an online filter shape used in an ECM in accordance with some examples of the present disclosure.

FIG. 11 is an illustration of a CCALF architecture, according to some examples of the present disclosure.

FIG. 12 is an illustration of a relative location of filtered chroma sample and its support in the luma plane for 4:2:0 chroma format with chroma location type 0. The illustration is in accordance with some examples of the present disclosure.

FIG. 13 is an illustration of a 25-tap long filter according to some examples of the present disclosure.

FIG. 14 is an illustration of a filter shape for a prediction signal or before a SAO signal in accordance with examples of the present disclosure.

FIG. 15 is an illustration of an adjusted ALF filter shape in accordance with some examples of the present disclosure.

FIG. 16 is a diagram illustrating a computing environment coupled with a user interface, according to some implementations of the present disclosure.

FIGS. 17A through 17C are diagrams illustrating symmetrical sample padding of luma ALF filtering in accordance with examples of the present disclosure.

FIGS. 18A through 18B are diagrams illustrating an existing ALF clip operation and a proposed clip with scale operation if sample difference is too large in accordance with examples of the present disclosure.

FIG. 19 is a flow chart illustrating a method for video decoding in accordance with some examples of the present disclosure.

FIG. 20 is a flow chart illustrating a method for video encoding corresponding to the method for video decoding as shown in FIG. 19 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

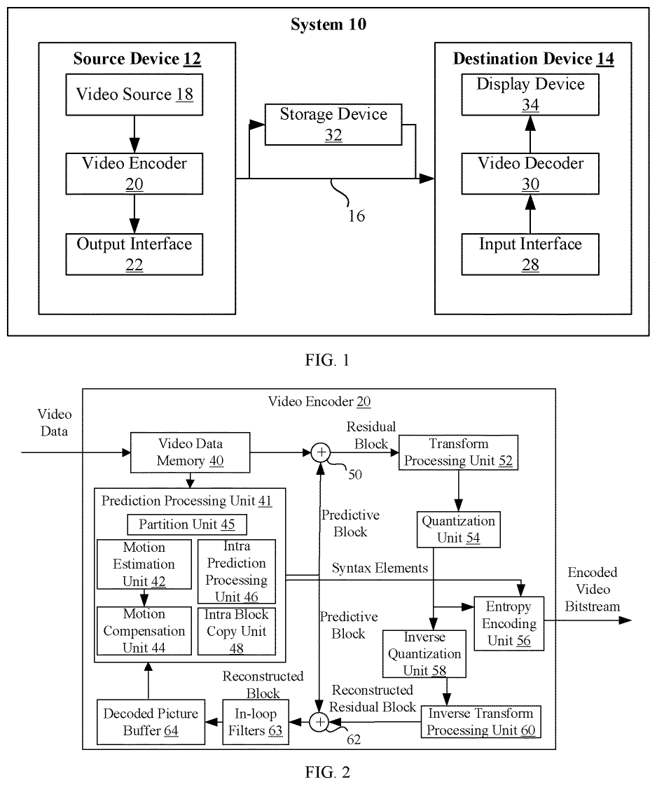

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter. The encoded video data may comprise a sequence of pictures, each of which may comprise one or more sample arrays, for example, luma (Y) only for monochrome; luma and two chroma in YCbCr or YCgCo domain; or green, blue, and red in GBR (also known as RGB) domain. For convenience of notation and terminology in this application, in some embodiments, variables and terms associated with each set of three sample arrays may be referred to as luma and chroma, where the two chroma arrays may be referred to as Cb and Cr, regardless of the actual color representation method in use. The video data may be in a chroma format of 4:0:0, 4:2:0, 4:2:2, or 4:4:4, but the present application is not limited thereto.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

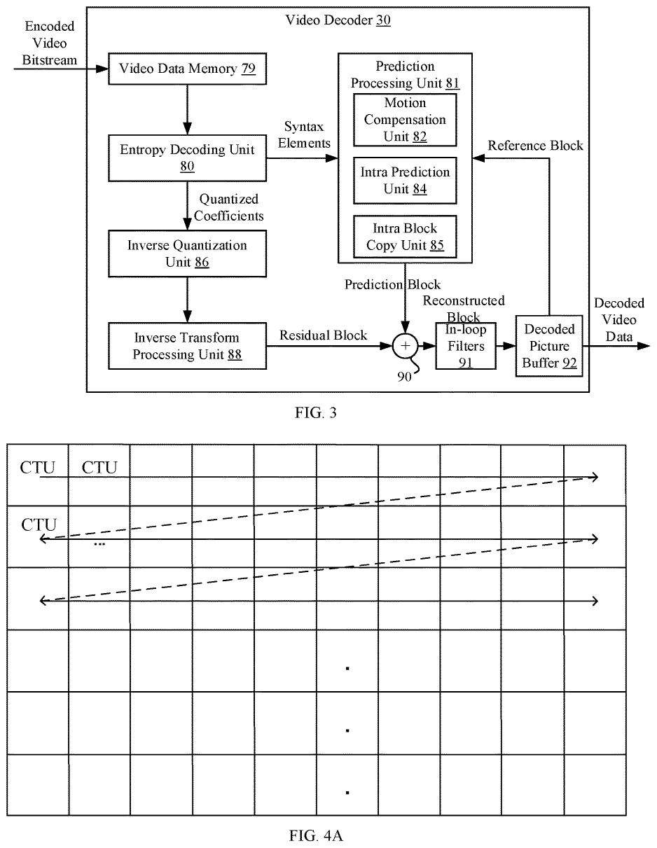

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component and two chroma components (which may represent Y, Cb and Cr in YCbCr domain; Y, Cg and Co in YCgCo domain; or G, B and R in RGB domain for convenience of notation and terminology in this application as described above) according to any other of the luma component and the two chroma components to modify said any component based on the selected offset. Further, it should also be illustrated that a first component mentioned herein may be any of the luma component and the two chroma components, a second component mentioned herein may be any other of the luma component and the two chroma components, and a third component mentioned herein may be a remaining one of the luma component and the two chroma components. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

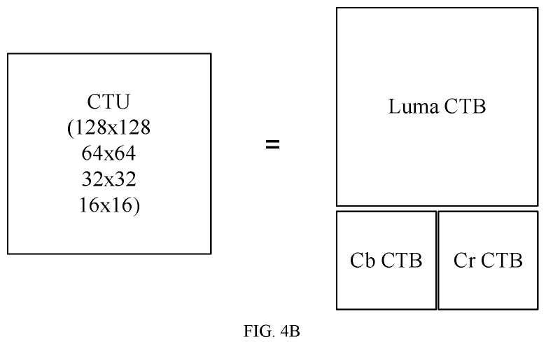

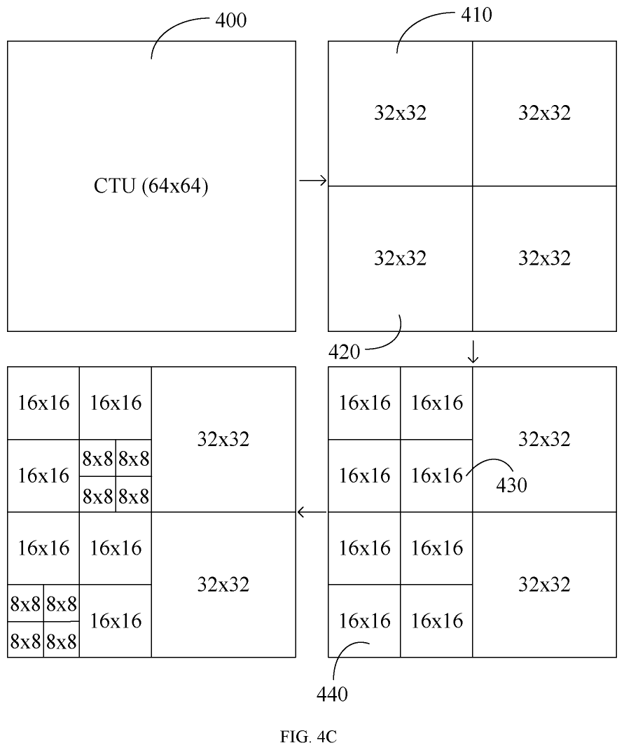

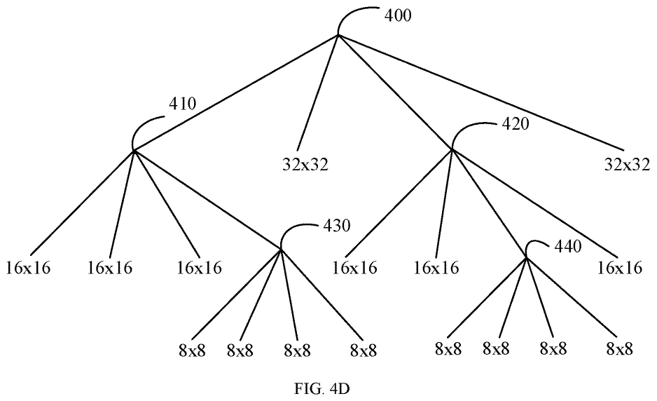

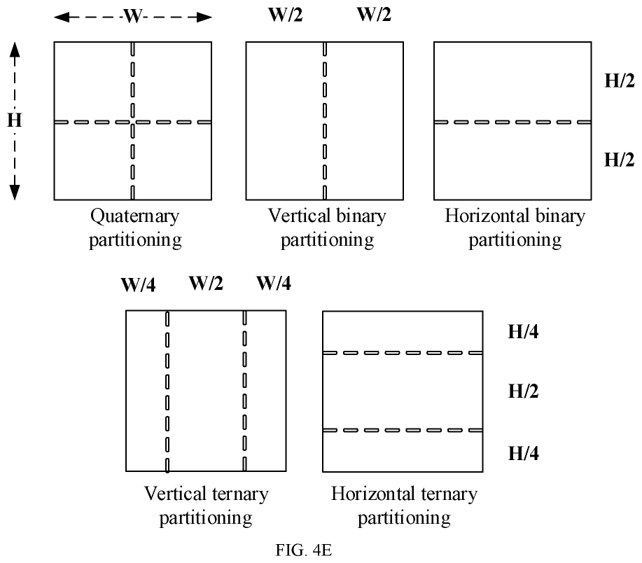

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

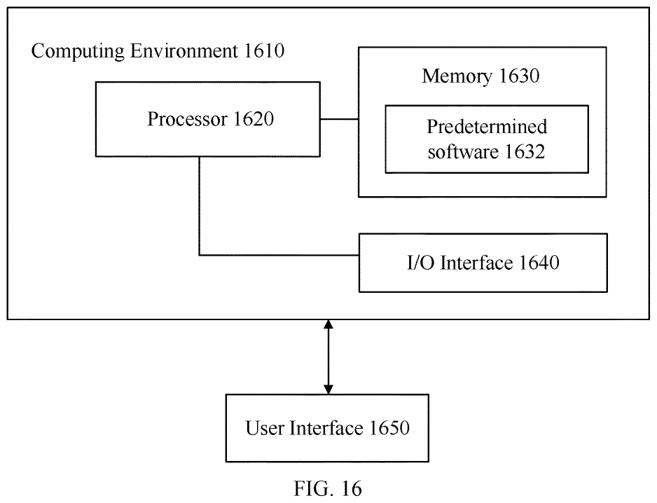

FIG. 16 shows a computing environment 1610 coupled with a user interface 1650. The computing environment 1610 can be part of a data processing server. The computing environment 1610 includes a processor 1620, a memory 1630, and an Input/Output (I/O) interface 1640.

The processor 1620 typically controls overall operations of the computing environment 1610, such as the operations associated with display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a Graphical Processing Unit (GPU), or the like.

The memory 1630 is configured to store various types of data to support the operation of the computing environment 1610. The memory 1630 may include predetermined software 1632. Examples of such data includes instructions for any applications or methods operated on the computing environment 1610, video datasets, image data, etc. The memory 1630 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1640 provides an interface between the processor 1620 and peripheral interface modules, such as a keyboard, a click wheel, buttons, and the like. The buttons may include but are not limited to, a home button, a start scan button, and a stop scan button. The I/O interface 1640 can be coupled with an encoder and decoder.

This disclosure is related to video coding and compression. More specifically, this disclosure relates to methods and apparatus on improving the coding efficiency of adaptive loop filter (ALF) and cross-component adaptive loop filter (CCALF).

Various video coding techniques may be used to compress video data. Video coding is performed according to one or more video coding standards. For example, nowadays, some well-known video coding standards include Versatile Video Coding (VVC), High Efficiency Video Coding (HEVC, also known as H.265 or MPEG-H Part 2) and Advanced Video Coding (AVC, also known as H.264 or MPEG-4 Part 10), which are jointly developed by ISO/IEC MPEG and ITU-T VCEG. AOMedia Video 1 (AV1) was developed by Alliance for Open Media (AOM) as a successor to its preceding standard VP9. Audio Video Coding (AVS), which refers to digital audio and digital video compression standard, is another video compression standard series developed by the Audio and Video Coding Standard Workgroup of China. Most of the existing video coding standards are built upon the famous hybrid video coding framework i.e., using block-based prediction methods (e.g., inter-prediction, intra-prediction) to reduce redundancy present in video images or sequences and using transform coding to compact the energy of the prediction errors. An important goal of video coding techniques is to compress video data into a form that uses a lower bit rate while avoiding or minimizing degradations to video quality.

The first generation AVS standard includes Chinese national standard “Information Technology, Advanced Audio Video Coding, Part 2: Video” (known as AVS1) and “Information Technology, Advanced Audio Video Coding Part 16: Radio Television Video” (known as AVS+). It can offer around 50% bit-rate saving at the same perceptual quality compared to MPEG-2 standard. The AVS1 standard video part was promulgated as the Chinese national standard in February 2006. The second generation AVS standard includes the series of Chinese national standard “Information Technology, Efficient Multimedia Coding” (knows as AVS2), which is mainly targeted at the transmission of extra HD TV programs. The coding efficiency of the AVS2 is double of that of the AVS+. In May 2016, the AVS2 was issued as the Chinese national standard. Meanwhile, the AVS2 standard video part was submitted by Institute of Electrical and Electronics Engineers (IEEE) as one international standard for applications. The AVS3 standard is one new generation video coding standard for UHD video application aiming at surpassing the coding efficiency of the latest international standard HEVC. In March 2019, at the 68-th AVS meeting, the AVS3-P2 baseline was finished, which provides approximately 30% bit-rate savings over the HEVC standard. Currently, there is one reference software, called high performance model (HPM), is maintained by the AVS group to demonstrate a reference implementation of the AVS3 standard.

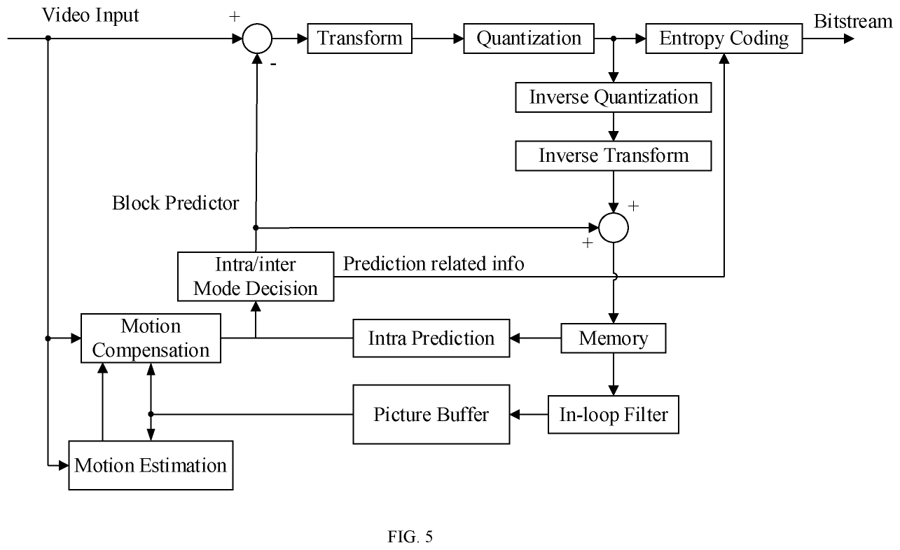

Like the HEVC, the AVS3 standard is built upon the block-based hybrid video coding framework. FIG. 5 gives the block diagram of a generic block-based hybrid video encoding system. The input video signal is processed block by block (called coding units (CUs)). Different from the HEVC which partitions blocks only based on quad-trees, in the AVS3, one coding tree unit (CTU) is split into CUs to adapt to varying local characteristics based on quad/binary/extended-quad-tree. Additionally, the concept of multiple partition unit type in the HEVC is removed, i.e., the separation of CU, prediction unit (PU) and transform unit (TU) does not exist in the AVS3; instead, each CU is always used as the basic unit for both prediction and transform without further partitions. In the tree partition structure of the AVS3, one CTU is firstly partitioned based on a quad-tree structure. Then, each quad-tree leaf node can be further partitioned based on a binary and extended-quad-tree structure. In FIG. 5, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and then quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used as reference to code future video blocks. To form the output video bit-stream, coding mode (inter or intra), prediction mode information, motion information, and quantized residual coefficients are all sent to the entropy coding unit to be further compressed and packed.

The first version of the HEVC standard was finalized in October 2013, which offers approximately 50% bit-rate saving or equivalent perceptual quality compared to the prior generation video coding standard H.264/MPEG AVC. Although the HEVC standard provides significant coding improvements than its predecessor, there is evidence that superior coding efficiency can be achieved with additional coding tools over HEVC. Based on that, both VCEG and MPEG started the exploration work of new coding technologies for future video coding standardization. One Joint Video Exploration Team (JVET) was formed in October 2015 by ITU-T VCEG and ISO/IEC MPEG to begin significant study of advanced technologies that could enable substantial enhancement of coding efficiency. One reference software called joint exploration model (JEM) was maintained by the JVET by integrating several additional coding tools on top of the HEVC test model (HM).

In October 2017, the joint call for proposals (CfP) on video compression with capability beyond HEVC was issued by ITU-T and ISO/IEC. In April 2018, 23 CfP responses were received and evaluated at the 10-th JVET meeting, which demonstrated compression efficiency gain over the HEVC around 40%. Based on such evaluation results, the JVET launched a new project to develop the new generation video coding standard that is named as Versatile Video Coding (VVC). In the same month, one reference software codebase, called VVC test model (VTM), was established for demonstrating a reference implementation of the VVC standard.

Like HEVC, the VVC is built upon the block-based hybrid video coding framework. FIG. 5 gives the block diagram of a generic block-based hybrid video encoding system. The input video signal is processed block by block (called coding units (CUs)). In VTM-1.0, a CU can be up to 128×128 pixels. However, different from the HEVC which partitions blocks only based on quad-trees, in the VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure. As shown in FIG. 4E, there are five splitting types, quaternary partitioning, horizontal binary partitioning, vertical binary partitioning, horizontal ternary partitioning, and vertical ternary partitioning. In FIG. 5, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream.

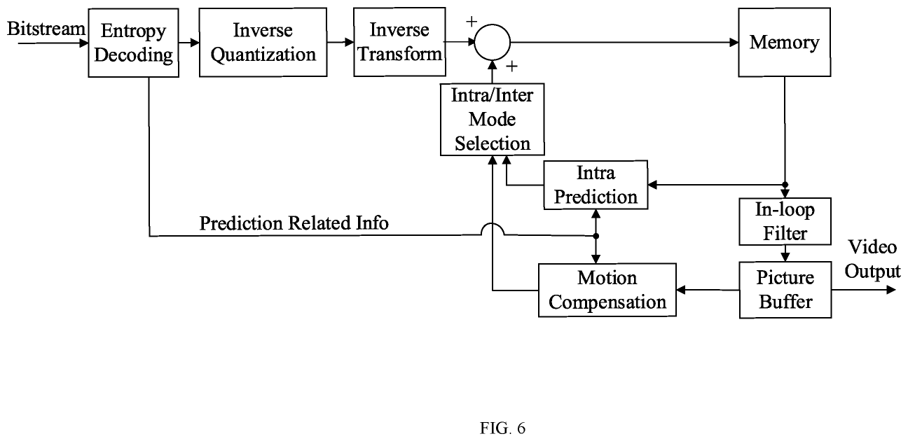

FIG. 6 gives a general block diagram of a block-based video decoder. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out to drive a display device, as well as used to predict future video blocks.

The main focus of the disclosure is to improve the adaptive loop filter (ALF) and cross-component adaptive loop filter (CCALF). The related background knowledge is elaborated in the following sections.

### 1.1 ALF in VVC

### 1.1.1 Filter Shapes, Linear Filtering and Adaptive Clipping

In VVC, ALF is applied to the output samples of SAO. Two filter shapes, 7×7 diamond shape and 5×5 diamond shape, are supported for luma and chroma components, respectively, as shown in FIG. 7. In FIG. 7, each square corresponds to a luma or a chroma sample and the center square corresponds to a current to-be-filtered sample. The filter coefficients use point-symmetry and each integer filter coefficient is represented with 7-bit fractional precision. In addition, the sum of coefficients of one filter is equal to 128, which is the fixed-point representation of 1.0 with 7-bit fractional precision:

$$2 {\sum }_{i = 0}^{N - 2} {c}_{i} + {c}_{N - 1} = 128 \qquad ( 1 )$$

where the number of coefficients Nis equal to 13 and 7 for 7×7 and 5×5 filter shape, respectively. A filtered sample value \tilde{R}(x,y) at coordinates (x,y) is derived by applying coefficient cᵢ to the reconstructed sample values R(x,y) as follows:

$$\tilde{R} ( x , y ) = [ {\sum }_{i = 0}^{N - 2} {c}_{i} ( R ( x + {x}_{i} , y + {y}_{i} ) + R ( x - {x}_{i} , y - {y}_{i} ) ) + {c}_{N - 1} R ( x , y ) + 64 ] ≫ 7 , \qquad ( 2 )$$

where (x+xᵢ,y+yᵢ) and (x−xᵢ,y−yᵢ) are the coordinates of the reconstructed samples corresponding to i-th coefficient cᵢ. Due to the constraint in equation (1), equation (2) can be written as:

$$\tilde{R} ( x , y ) = R ( x , y ) + \{ [ {\sum }_{i = 0}^{N - 2} {c}_{i} ( ( R ( x + {x}_{i} , y + {y}_{i} ) - R ( x , y ) ) + R ( x - {x}_{i} , y - {y}_{i} ) - R ( x , y ) ) ) + 64 ] ≫ 7 \qquad ( 3 )$$

In VVC, the possibility to clip the difference between the neighboring sample value and the current to-be-filtered sample is added to equation (3) as follows:

$$\tilde{R} ( x , y ) = R ( x , y ) + \{ [ {\sum }_{i = 0}^{N - 2} {c}_{i} {f}_{i} + 64 ] ≫ 7 \} , where \qquad ( 4 )$$

$${f}_{i} = min ( {b}_{i} , max ( - {b}_{i} , R ( x + {x}_{i} , y + {y}_{i} ) - R ( x , y ) ) ) + min ( {b}_{i} , max ( - {b}_{i} , R ( x - {x}_{i} , y - {y}_{i} ) - R ( x , y ) ) ) \qquad ( 5 )$$

bᵢ is the clipping parameter for a coefficient cᵢ determined by a clipping index dᵢ. bᵢ is derived as follows:

$${b}_{i} = \{ \begin{matrix}{2}^{BD} , when {d}_{i} = 0 \\ {2}^{BD - 1 - 2 {d}_{i}} , otherwise\end{matrix} , \qquad ( 6 )$$

where BD is the sample bit depth and dᵢ can be 0, 1, 2 or 3.

### 1.1.2 Luma Sub-Block Level Filter Adaptation

In VVC, sub-block level filter adaption is only applied to luma component. Each 4×4 luma block is classified based on its directionality and 2D Laplacian activity. First, the values of sample gradients for horizontal, vertical and two diagonal directions are calculated:

$${H}_{k , l} = \vert 2 R ( k , l ) - R ( k - 1 , l ) - R ( k + 1 , l ) \vert , \qquad ( 7 )$$

$${V}_{k , l} = \vert 2 R ( k , l ) - R ( k , l - 1 ) - R ( k , l + 1 ) \vert ,$$

$${D0}_{k , l} = \vert 2 R ( k , l ) - R ( k - 1 , l - 1 ) - R ( k + 1 , l + 1 ) \vert ,$$

$$D {1}_{k , l} = \vert 2 R ( k , l ) - R ( k - 1 , l + 1 ) - R ( k + 1 , l - 1 ) \vert .$$

Based on the sample gradients, sub-block horizontal gradient, gₕ, vertical gradient, gᵥ, and two diagonal gradients, g_{d0} and g_{d1}, are calculated as

$${g}_{h} = {\sum }_{k = i - 2}^{i + 5} {\sum }_{l = j - 2}^{j + 5} {H}_{k , l} , \qquad ( 8 )$$

$${g}_{v} = {\sum }_{k = i - 2}^{i + 5} {\sum }_{l = j - 2}^{j + 5} {V}_{k , l} ,$$

$${g}_{d 0} = {\sum }_{k = i - 2}^{i + 5} {\sum }_{l = j - 2}^{j + 5} D {0}_{k , l} ,$$

$${g}_{d 1} = {\sum }_{k = i - 2}^{i + 5} {\sum }_{l = j - 2}^{j + 5} D {1}_{k , l}$$

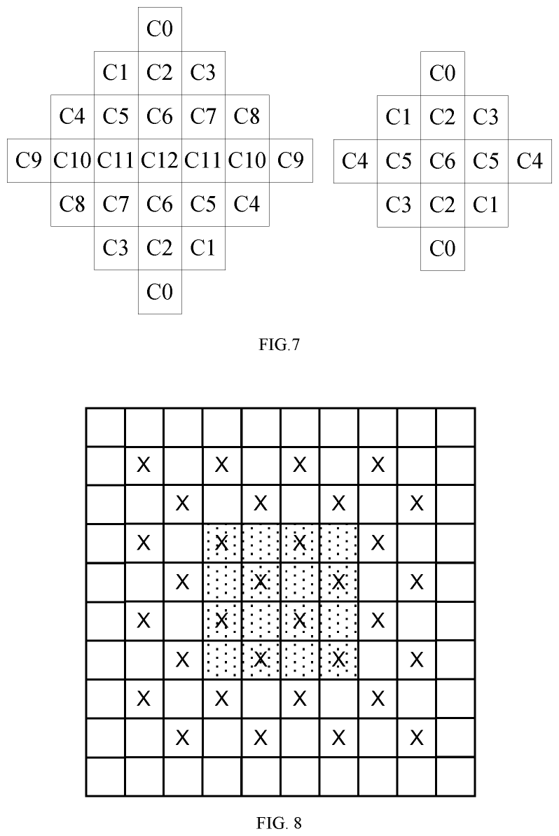

Indices i and j refer to the coordinates of the upper left sample in the 4×4 luma block. As it can be seen from equation (8), the sum of sample gradients within a 10×10 luma window that covers the target 4×4 block is used for classifying that block. To reduce the complexity, only gradient of every second sample in a 10×10 window is calculated as illustrated in FIG. 8. The values of other sample gradients are set to 0.

Second, to assign the directionality D, the ratio of the maximum and the minimum of the sub-block horizontal and vertical gradients

$${g}_{h , v}^{max} = max ( {g}_{h} , {g}_{v} ) , {g}_{h , v}^{min} = min ( {g}_{h} , {g}_{v} ) , \qquad ( 9 )$$

and the ratio of the maximum and the minimum of two sub-block diagonal gradients

$${g}_{d 0 , d 1}^{max} = max ( {g}_{d 0} , {g}_{d 1} ) , {g}_{d 0 , d 1}^{min} = min ( {g}_{d 0} , {g}_{d 1} ) , \qquad ( 10 )$$

are compared against each other with a set of thresholds t₁ and t₂:

Step 1: If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} ,$$

### D is set to 0.

Step 2: If

$${g}_{h , v}^{max} / {g}_{h , v}^{min} > {g}_{d 0 , d 1}^{max} / {g}_{d 0 , d 1}^{min} ,$$

the directionality D is calculated in Step 3, otherwise in Step 4.

Step 3: If

$${g}_{h , v}^{max} > {t}_{2} \cdot {g}_{h , v}^{min} ,$$

D is set to 2, otherwise D is set to 1.

Step 4: If

$${g}_{d 0 , d 1}^{max} > {t}_{2} \cdot {g}_{d 0 , d 1}^{min} ,$$

D is set to 4, otherwise D is set to 3.

Each subsequent step in the above calculation of D is only executed if there is no value assigned to D in the previous steps. Third, an activity value A is calculated as

$$A = ( {\sum }_{k = i - 2}^{i + 5} {\sum }_{l = j - 2}^{j + 5} ( {V}_{k , l} + {H}_{k , l} ) ) ≫ ( BD - 2 ) \qquad ( 11 )$$

A is further mapped to the range of 0 to 4: Â=Q_{min(A,15)},where {Qₙ}={0,1,2,2,2,2,2,3,3,3,3,3,3,3,3,4}. Finally, each 4×4 luma block is categorized into one of the 25 classes:

$$C = 5 D + \hat{A} \qquad ( 12 )$$

Each class can have its own filter assigned.

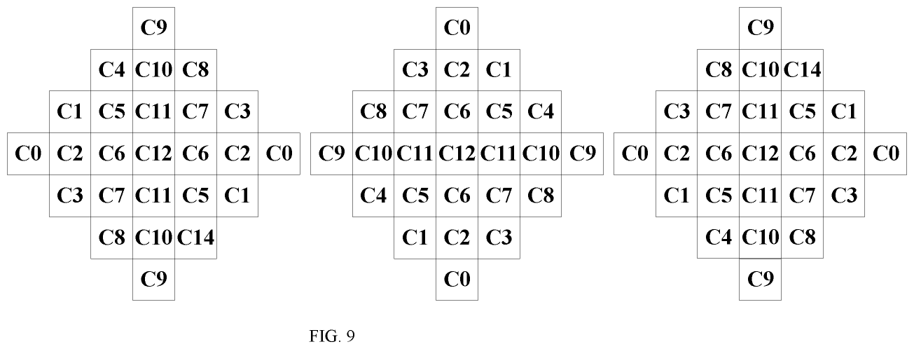

Before filtering each 4×4 luma block, a geometric transformation, such as 90-degree rotation, diagonal or vertical flip, is applied to the filter coefficients, as illustrated in FIG. 9, depending on the sub-block gradient value as specified in Table 1.

TABLE 1
Geometric transformation based on sub-block gradient values

| Sub-block gradient values | Transformation |
|---|---|
| g_{d1} < g_{d0} and gₕ < gᵥ | No transformation |
| g_{d1} < g_{d0} and gᵥ ≤ gₕ | Diagonal flip |
| g_{do} ≤ g_{d1} and gₕ < gᵥ | Vertical flip |
| g_{do} ≤ g_{d1}and gᵥ ≤ gₕ | 90-degree rotation |

### 1.1.3 Coding Tree Block Level Filter Adaptation

In addition to the luma 4×4 block-level filter adaptation, ALF supports CTB-level filter adaptation. A luma CTB can use a filter set calculated for the current slice or one of the filter sets calculated for the already coded slices. It can also use one of the 16 offline trained filter sets. Within each luma CTB, which filter from the chosen filter set should be applied to each 4×4 block, is determined by the class C calculated in equation (12) for this block.

Chroma uses only CTB-level filter adaptation. Up to 8 filters can be used for chroma components in a slice. Each CTB can select one of these filters.

### 1.1.4 Syntax Design

Filter coefficients and clipping indices are carried in ALF APSs. An ALF APS can include up to 8 chroma filters and one luma filter set with up to 25 filters. An index i_{C} is also included for each of the 25 luma classes. Classes having the same index i_{C} share the same filter. By merging different classes, the number of bits required to represent the filter coefficients is reduced. The absolute value of a filter coefficient is represented using a 0th order Exp-Golomb code followed by a sign bit for a non-zero coefficient. When clipping is enabled, a clipping index is also signaled for each filter coefficient using a two-bit fixed-length code. The storage needed for ALF coefficients and clipping indices within an APS is at most 3480 bits. Up to 8 ALF APSs can be used by the decoder at the same time.

Filter control syntax elements include two types of information. First, ALF on/off flags are signaled at sequence, picture, slice and CTB levels. Chroma ALF can be enabled at picture and slice level only if luma ALF is enabled at the corresponding level. Second, filter usage information is signaled at picture, slice and CTB level, if ALF is enabled at that level. Referenced ALF APSs IDs are coded at a slice level or at a picture level if all the slices within the picture use the same APSs. Luma component can reference up to 7 ALF APSs and chroma components can reference 1 ALF APS. For a luma CTB, an index is signaled indicating which ALF APS or offline trained luma filter set is used. For a chroma CTB, the index indicates which filter in the referenced APS is used.

3.1.4.1 Adaptive loop filter data syntax

| | Descriptor |
|---|---|
| alf_data( ) { | |
| alf_luma_filter_signal_flag | u(1) |
| if( aps_chroma_present_flag ) { | |
| alf_chroma_filter_signal_flag | u(1) |
| alf_cc_cb_filter_signal_flag | u(1) |
| alf_cc_cr_filter_signal_flag | u(1) |
| } | |
| if( alf_luma_filter_signal_flag ) { | |
| alf_luma_clip_flag | u(1) |
| alf_luma_num_filters_signalled_minus1 | ue(v) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; | |
| sfIdx++ ) | |
| for( j = 0; j < 12; j++ ) { | |
| alf_luma_coeff_abs[ sfIdx ][ j ] | ue(v) |
| if( alf luma_coeff_abs[ sfIdx ][ j ] ) | |
| alf_luma_coeff_sign[ sfIdx ][ j ] | u(1) |
| } | |
| if( alf luma_clip_flag ) | |
| for( sfIdx = 0; sfIdx <= alf_luma_num_filters_signalled_minus1; | |
| sfIdx++ ) | |
| for( j = 0; j < 12; j++ ) | |
| alf_luma_clip_idx[ sfIdx ][ j ] | u(2) |
| } | |
| if( alf_chroma_filter_signal_flag ) { | |
| alf_chroma_clip_flag | u(1) |
| alf_chroma_num_alt_filters_minus1 | ue(v) |
| for( altIdx = 0; altIdx <= alf_chroma_num_alt_filters_minus1; altIdx++ | |
| ) { | |
| for( j = 0; j < 6; j++ ) { | |
| alf_chroma_coeff_abs[ altIdx ][ j ] | ue(v) |
| if( alf_chroma_coeff_abs[ altIdx ][ j ] > 0 ) | |
| alf_chroma_coeff_sign[ altIdx ][ j ] | u(1) |
| } | |
| if( alf_chroma_clip_flag ) | |
| for( j = 0; j < 6; j++ ) | |
| alf_chroma_clip_idx[ altIdx ][ j ] | u(2) |
| } | |
| } | |
| if( alf_cc_cb_filter_signal_flag ) { | |
| alf_cc_cb_filters_signalled_minus1 | ue(v) |
| for( k = 0; k < alf_cc_cb_filters_signalled_minus1 + 1; k++ ) { | |
| for( j = 0; j < 7; j++ ) { | |
| alf_cc_cb_mapped_coeff_abs[ k ][ j ] | u(3) |
| if( alf_cc_cb_mapped_coeff_abs[ k ][ j ] ) | |
| alf_cc_cb_coeff_sign[ k ][ j ] | u(1) |
| } | |
| } | |
| } | |
| if( alf_cc_cr_filter_signal_flag ) { | |
| alf_cc_cr_filters_signalled_minus1 | ue(v) |
| for( k = 0; k < alf_cc_cr filters_signalled_minus1 + 1; k++ ) { | |
| for( j = 0; j < 7; j++ ) { | |
| alf_cc_cr_mapped_coeff_abs[ k ][ j ] | u(3) |
| if( alf_cc_cr_mapped_coeff_abs[ k ][ j ] ) | |
| alf_cc_cr_coeff_sign[ k ][ j ] | u(1) |
| } | |
| } | |
| } | |
| } | |

### 1.1.5 Line Buffer Reduction

To reduce the storage requirement for ALF, VVC employs line buffer boundary processing. In VVC, line buffer boundaries are placed 4 luma samples and 2 chroma samples above horizontal CTU boundaries. When applying ALF to a sample on one side of a line buffer boundary, samples on the other side of the line buffer boundary cannot be used.

### 1.2 ALF in ECM

### 1.2.1 ALF Simplification Removal

ALF gradient subsampling and ALF virtual boundary processing are removed. Block size for classification is reduced from 4×4 to 2×2. Filter size for both luma and chroma, for which ALF coefficients are signaled, is increased to 9×9.

1.2.2 ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signaled. Which filter from a set Fᵢ is used for a given sample is decided by a class Cᵢ assigned to this sample using classifier Cᵢ.

### 1.2.3 Filtering

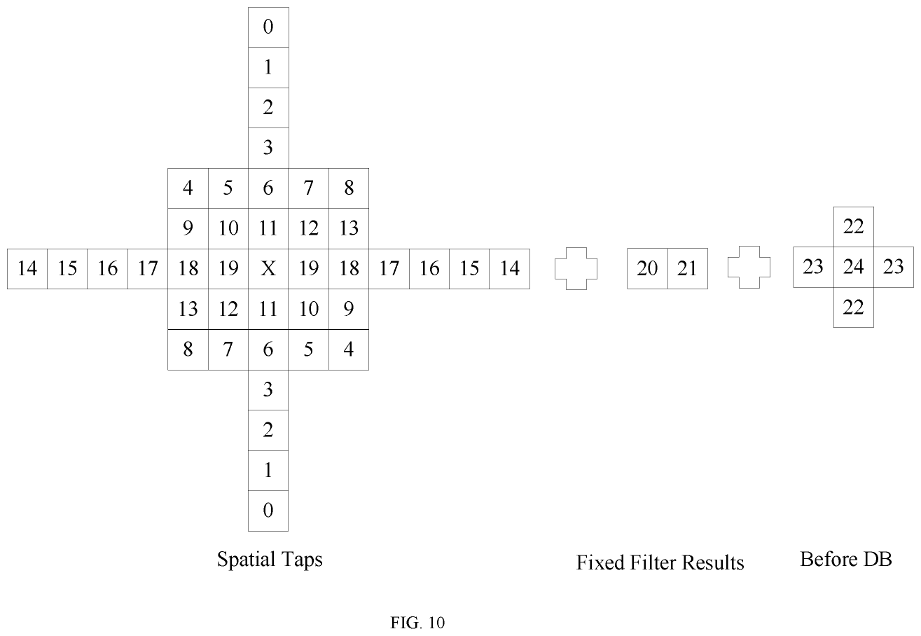

At first, two 13×13 diamond shape fixed filters F₀ and F₁ are applied to derive two intermediate samples R₀(x,y) and R₁(x,y). After that, F₂ is applied to R₀(x,y), R₁(x,y), neighboring samples, and samples before deblocking filter (DBF) to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] + [ {\sum }_{i = 22}^{24} {c}_{i} ( {h}_{i , 0} + {h}_{i , 1} ) ] \qquad ( 13 )$$

where f_{i,j} (where i∈[0,19], j∈[0,1]) is the clipped difference between a neighboring sample before DBF and current sample R(x,y), gᵢ (where i∈[20,21]) is the clipped difference between the intermediate sample Rᵢ₋₂₀(x,y) and current sample R(x,y), h_{i,j} (where i∈[22,24], j∈[0,1]) is the clipped difference between a neighboring sample before DBF and current sample R(x,y). Here, the value range of “i” in h_{i,j} is different from the value range of “i” in f_{i,j}. The filter coefficients cᵢ, i=0, . . . , 24, are signaled. The filter shape of F₂ is presented in FIG. 10.

### 1.2.4 Classification

Based on directionality Dᵢ and activity Âᵢ, a class Cᵢ is assigned to each 2×2 block:

$${C}_{i} = {\hat{A}}_{i} * {M}_{D , i} + {D}_{i} \qquad ( 14 )$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad ( 15 )$$

with a set of thresholds. The directionality D₂ is derived as in VVC using thresholds 2 and 4.5. For D₀ and D₁, horizontal/vertical edge strength

$${E}_{HV}^{i}$$

and diagonal edge strength

$${E}_{D}^{i}$$

are calculated first. Thresholds Th=[1.25, 1.5, 2, 3, 4.5, 8] are used. Edge strength

$${E}_{HV}^{i}$$

is 0 if

$${r}_{h , v}^{i} \leq T h [ 0 ] ;$$

otherwise,

$${E}_{HV}^{i}$$

is the maximum integer such that

$${r}_{h , v}^{i} > T h [ {E}_{HV}^{i} - 1 ] .$$

Edge strength

$${E}_{D}^{i}$$

is 0 if

$${r}_{d 1 , d 2}^{i} \leq T h [ 0 ] ;$$

otherwise,

$${E}_{D}^{i}$$

is the maximum integer such that

$${r}_{d 1 , d 2}^{i} > T h [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using the Table 2 (a); otherwise, diagonal edges are dominant, the Dᵢ is derived by using Table 2 (b).

TABLE 2
$Mapping of {E}_{D}^{i} and {E}_{H V}^{i} to {D}_{i}$

| (a) | | | | | | | | (b) | | | | | | | |
|---|---|---|---|---|---|---|---|---|---|---|---|---|---|---|---|
| | ${E}_{D}^{i}$ | | | | | | | | ${E}_{HV}^{i}$ | | | | | | |
| ${E}_{HV}^{i}$ | 0 | 1 | 2 | 3 | 4 | 5 | 6 | ${E}_{D}^{i}$ | 0 | 1 | 2 | 3 | 4 | 5 | 6 |
| 0 | 0 | 0 | 0 | 0 | 0 | 0 | 0 | 0 | 28 | 0 | 0 | 0 | 0 | 0 | 0 |
| 1 | 1 | 2 | 0 | 0 | 0 | 0 | 0 | 1 | 29 | 30 | 0 | 0 | 0 | 0 | 0 |
| 2 | 3 | 4 | 5 | 0 | 0 | 0 | 0 | 2 | 31 | 32 | 33 | 0 | 0 | 0 | 0 |
| 3 | 6 | 7 | 8 | 9 | 0 | 0 | 0 | 3 | 34 | 35 | 36 | 37 | 0 | 0 | 0 |
| 4 | 10 | 11 | 12 | 13 | 14 | 0 | 0 | 4 | 38 | 39 | 40 | 41 | 42 | 0 | 0 |
| 5 | 15 | 16 | 17 | 18 | 19 | 20 | 0 | 5 | 43 | 44 | 45 | 46 | 47 | 48 | 0 |
| 6 | 21 | 22 | 23 | 24 | 25 | 26 | 27 | 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signaled, each set may have up to 25 filters.

### 1.2.5 Alternative 2×2 ALF Classifier

Classification in ALF is extended with an additional alternative classifier. For a signaled luma filter set, a flag is signaled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$$class\_index = ( sum * 25 ) ≫ ( sample bit depth + 2 ) . \qquad ( 16 )$$

### 1.2.6 Residual Based Classifier

Classification in ALF is extended with a third classifier based on luma residual sample values. For each 2×2 luma block, the sum of absolute values of the residual samples in a neighbouring 8×8 window is calculated, and the class index is derived as:

$$classIdx = sum ≫ ( sample bit depth - 4 ) .$$

The value of classIdx is in the range of 0 to 24, same as in ECM-8.0. The classifier usage is signaled for each luma filter set in APS.

### 1.3 CCALF in VVC

### 1.3.1 Filter Shapes and Precision

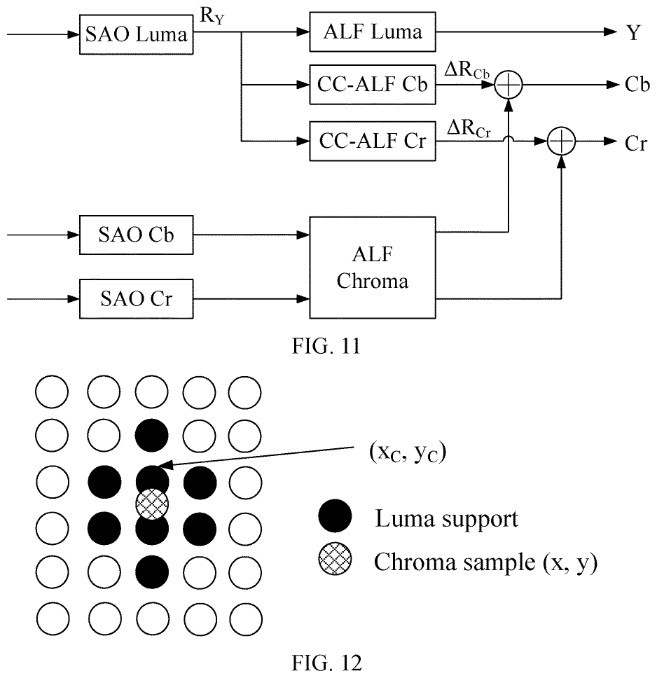

CCALF uses the luma sample values to refine the chroma sample values within the ALF process. As shown in FIG. 11, a linear filtering operation takes the luma sample values as input and generates the correction values for the chroma sample values. The correction is generated independently for each chroma component i, i∈{Cb, Cr} and can be represented by:

$$Δ {R}_{i} ( x , y ) = {\sum }_{( {x}_{0} , {y}_{0} ) ∈ {S}_{i}} {R}_{Y} ( {x}_{C} + {x}_{0} , {y}_{C} + {y}_{0} ) {c}_{i} ( {x}_{0} , {y}_{0} ) ,$$

where (x,y) is the sample location of the chroma component i, (x_{C},y_{C}) is the luma sample location derived from (x,y), (x₀,y₀) are the filter support offset around (x_{C},y_{C}), Sᵢ is the filter support region in luma for the chroma component i. The luma location (x_{C},y_{C}) is determined based on the spatial scaling factor between the luma and chroma planes. The sample values in the luma support region are also inputs to the ALF luma stage and correspond to the output of the SAO stage. In some examples, the chroma sample values might be used to refine the luma sample values within the ALF process.

As shown in FIG. 12, the CCALF filter has a diamond shape. As seen in FIG. 12, for a 4:2:0 video sequence, with chroma location type 0, i.e., when the chroma samples are horizontally co-sited with the even numbered columns of the luma samples and vertically interstitial between the rows of the luma samples, the center of the diamond is aligned with a chroma sample location.

CCALF coefficients have a greater degree of flexibility compared to regular ALF coefficients, since no symmetry constraints are enforced. However, two limitations are enforced:

1) To preserve DC neutrality, the sum of CCALF coefficient values is required to be zero. As a result, only seven of the eight CCALF coefficients need to be signaled in the bitstream, and the coefficient at location (x_{C},y_{C}) is derived at the decoder.

2) The absolute value of CCALF coefficients is restricted to be either zero or an integer power of two, specifically {0, 1, 2, 4, 8, 16, 32, 64}. This enables implementations to use variable bit-shift operations in place of multiplications for CCALF, if desired.

### 1.3.2 Syntax Design

The maximum number of filters per chroma component of a picture was four in the final design of VVC. A different set of CCALF coefficients can be selected for each CTU of a chroma component. As is the case for the regular ALF coefficients, CCALF coefficients are signaled within an ALF APS. Each ALF APS contains up to four CCALF filters for each chroma component. While CCALF can be enabled at a sequence level, it can only be enabled if ALF is also enabled for the sequence. Similarly, CCALF can be enabled at picture and slice level only if luma ALF is enabled at the corresponding level.

### 1.3.3 Line Buffer Reduction

As described in section 3.1.5, the luma and the chroma line buffer boundaries are four and two samples, respectively, above the CTU boundary. For the 4:2:0 chroma format, this results in line buffer boundaries that are aligned for chroma and luma. However, for 4:2:2 and 4:4:4 chroma formats, the chroma and the luma line buffer boundaries are not aligned with each other. As a result of this misalignment, for 4:2:2 and 4:4:4 chroma formats, CC-ALF is not applied to the rows three and four samples above the CTU boundary.

### 1.4 CCALF in ECM

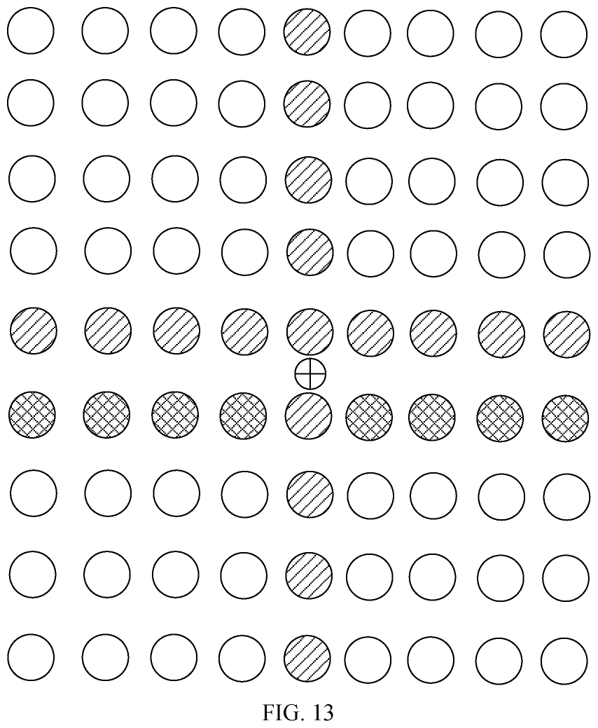

The CCALF process uses a linear filter to filter luma sample values and generate a residual correction for the chroma samples. A 25-tap large filter is used in CCALF process, which is illustrated in FIG. 13. For a given slice, the encoder can collect the statistics of the slice, analyze them and can signal up to 16 filters through APS.

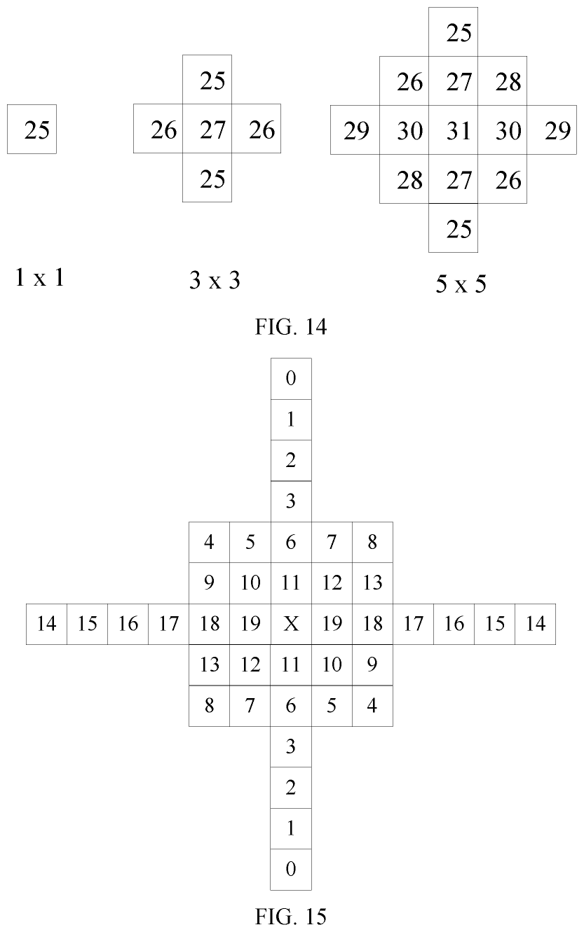

FIG. 14 illustrates a filter shape for a prediction signal or before a SAO signal in accordance with examples of the present disclosure. In some embodiments, it is provided to take the spatial neighboring pixels in prediction signal as additional ALF equation input. Various filter shapes may be used to extract the information in prediction signal. For example, the filter shape may be 1×1, 3×3 or 5×5 as shown in FIG. 14.

FIG. 15 illustrates an adjusted ALF filter shape in accordance with some examples of the present disclosure. In some embodiments, it is provided to change the chroma ALF filter shape from diamond shape to long cross shape as shown in FIG. 15, which is unified with the luma ALF filter shape.

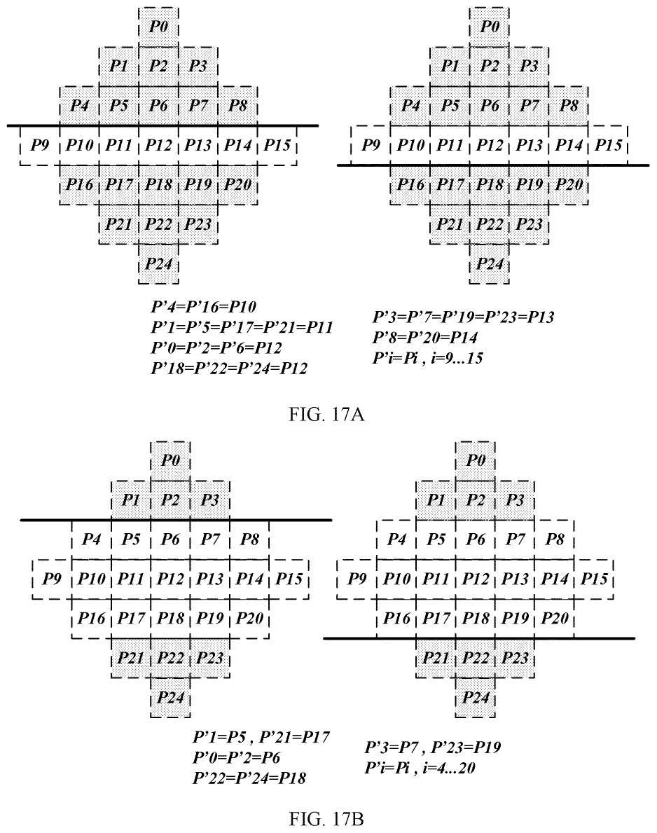

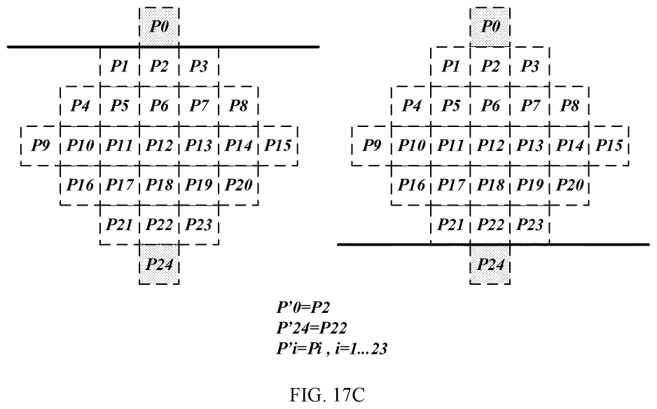

FIGS. 17A through 17C illustrate symmetrical sample padding of luma ALF filtering in accordance with examples of the present disclosure. In some embodiments, symmetrical sample padding is applied when the filter shape of the additional input with its central position aligned with the to be filtered sample crosses the virtual boundary (line buffer boundary) or picture (slice, tile) boundary. For example, assume online ALF filter takes residual samples as additional input, the filter shape of the fixed filter to be applied to the residual signal or the filter shape of the online filter which directly applies to residual signal is 7×7, the filter shape of the residual signal with its central position aligned with the to be filtered sample crosses the line buffer boundary, the symmetrical sample padding is conducted as shown in FIGS. 17A-C, where p₁₂ masks the collocated residual pixel of the to be filtered sample, p₀ to p₂₄ are the original residual samples,

$${p}_{0}^{′} to {p}_{24}^{′}$$

are the modified residual sample values, Bold lines are line buffer boundaries. Shaded samples represent padded residual samples. In a word, with symmetrical sample padding, the additional input samples which are not in the same boundary side with the collocated additional input sample of the to be filtered sample and the additional input symmetrical samples which are in the same boundary side with the collocated additional input sample of the to be filtered sample are both modified in a symmetry manner.

### Problem Statement

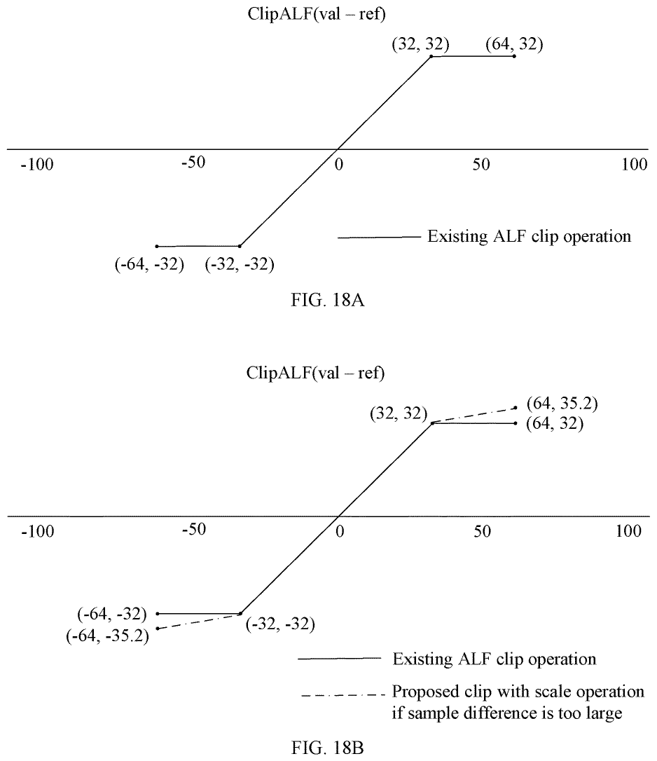

(1) Although ALF and CCALF has been improved in ECM, there is room to further improve its performance. According to equation (5), sample differences are clipped before applying ALF coefficients. The sample difference physically means the similarity of the neighboring sample, R(x+xᵢ,y+yᵢ), and the center sample, R(x,y). In one or more examples as illustrated in Equation (13) of Section 1.2.3 “Filtering”, the sample differences may correspond to f_{i,j} (where i∈[0,19], j∈[0,1]) or h_{i,j} (where i∈[22,24], j∈[0,1]). The clip operation keeps information when the sample difference is within a range, and discards information if the difference is outside the range. However, the discarded information may be still meaningful and utilized to improve the coding efficiency. The information, or sample differences larger than a threshold, can be scaled (down) to be combined with other ALF inputs. FIGS. 18A-18B show an illustration.

(2) There is redundancy in the signaling of ALF coefficients and clip indices. For example, as shown in Section 3.1.4, the VVC ALF signals alf_luma_clip_idx even when alf_luma_coeff_abs is 0, which equivalently means not applying filter on ALF input samples. In VVC, for a 10-bit sequence, the clip index {0, 1, 2, 3} indicates a {1024, 8, 32, 128} clipping range applied on ALF input samples.

In this disclosure, to address the issues as pointed out in the “problem statement” section, methods are provided to further improve the existing design of the ALF. In general, the main features of the proposed technologies in this disclosure are summarized as follows.
1. Before applying ALF coefficients, the dynamic range of input sample differences are divided into N parts (N is an integer that is no less than 2), one part is or some parts are within a range [min, max], the other part is or the other parts are outside the range. Apply M different ALF coefficients to the N divided parts.
2. Each sample difference may have its own coefficients, with at least one coefficient applied on the outside range part.
3. The N divided parts may share the same coefficients. In some examples, signal 1 additional ALF coefficient, both parts below the lower bound and above the upper bound use the same 1 coefficient.
4. Dividing into 2 parts may be determined by signaling an index indicating a range [min, max], the index to range mapping table may be predefined. In one or more examples, the index may be a 2-bit index indicating a range of [8, 32], or [32, 128], or [128, 1024]. In one or more examples, the index may be a 2-bit index indicating a range of [32, 128], or [128, 512], or [512, 4096].
5. The sample differences and the target filter sample can be the same color component, such as luma ALF and chroma ALF.
6. The sample differences (luma) and the target filter sample (chroma) may be different color components, such as CCALF.

According to some examples, before applying ALF coefficients, input sample differences are divided into 2 parts, one part is within a range [min, max], the other part is outside the range. The processor may apply 2 different ALF coefficients to the 2 divided parts. At a side of an encoder, the processor may signal 1 additional ALF coefficient for the outside part.

According to some examples, the 1 additional coefficient is signaled for each sample difference, or shared for all sample differences that are outside the range.

According to some examples, dividing into 2 parts is determined by signaling an index indicating a range [min, max], the index to range mapping table can be predefined.

According to some examples, before applying ALF coefficients, input sample differences are divided into 3 parts, one part is within a range [min, max], one part is below the lower bound, the other part is above the upper bound. The processor may apply 3 different ALF coefficients to the 3 divided parts. At the side of the encoder, the processor may signal 2 additional ALF coefficient for the outside part.

According to some examples, the 2 additional coefficient is signaled for each sample difference, or shared for all sample differences that are below the lower bound or above the upper bound.

According to some examples, the processor may divide into 3 parts is determined by signaling an index indicating a range [min, max]; according to some examples, the index to range mapping table can be predefined.

According to some examples, the sample differences and the target filter sample in the examples above may be the same color component, such as luma ALF and chroma ALF.

According to some examples, the sample differences (luma) and the target filter sample (chroma) in the examples above may be different color components, such as CCALF.

In some examples, the disclosed methods may be applied independently or jointly.

To reduce the redundant signaling in the Problem Statement (2), it is provided in this disclosure to signal alf_luma_clip_idx conditioned on the value of alf_luma_coeff_abs. The following method can also be applied on chroma ALF or CCALF similarly.
1. Receiving, from a bitstream, a first syntax element representing ALF coefficient
2. Decoding, a second syntax element based on values of the first syntax element;
   wherein the second syntax element indicates clipping range of ALF input samples.

For example,
1. Receiving alf_luma_coeff_abs
2. Decoding alf_luma_clip_idx based on the value of alf_luma_coeff_abs, e.g.,
   if (alf_luma_coeff_abs !=0 && alf_luma_clip_flag)
      signals alf_luma_clip_idx

Signaling in VVC ALF:

| | |
|---|---|
| for( sfIdx = 0; sfIdx <= alf_luma_num_filters_signalled_minus1; | |
| sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; | |
| sfIdx++ ) | |
| for( j = 0; j < 12; j++ ) | |
| alf_luma_clip_idx[ sfIdx ][ j ] | u(2) |

### Syntax Example 1

| | |
|---|---|
| for( sfIdx = 0; sfIdx <= alf_luma_num_filters_signalled_minus1; | |
| sfIdx++ ) | |
| for( j = 0; j < 12; j++ ) { | |
| alf_luma_coeff_abs[ sfIdx ][ j ] | ue(v) |
| if( alf luma_coeff_abs[ sfIdx ][ j ] ) { | |
| alf_luma_coeff_sign[ sfIdx ][ j ] | u(1) |
| if( alf_luma_clip_flag ) | |
| alf_luma_clip_idx[ sfIdx ][ j ] | u(2) |
| } | |
| } | |

### Syntax Example 2

| | |
|---|---|
| if( alf_luma_clip_flag ) { | |
| for( sfIdx = 0; sfIdx <= alf_luma num_filters_signalled_minus1; | |
| sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) { | |
| alf_luma_coeff_sign[ sfIdx ][ j ] | u(1) |
| alf_luma_clip_idx[ sfIdx ][ j ] | u(2) |
| } | |
| } | |
| } | |
| else { | |
| for( sfIdx = 0; sfIdx <= alf_luma_num_filters_signalled_minus1; | |
| sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| } | |

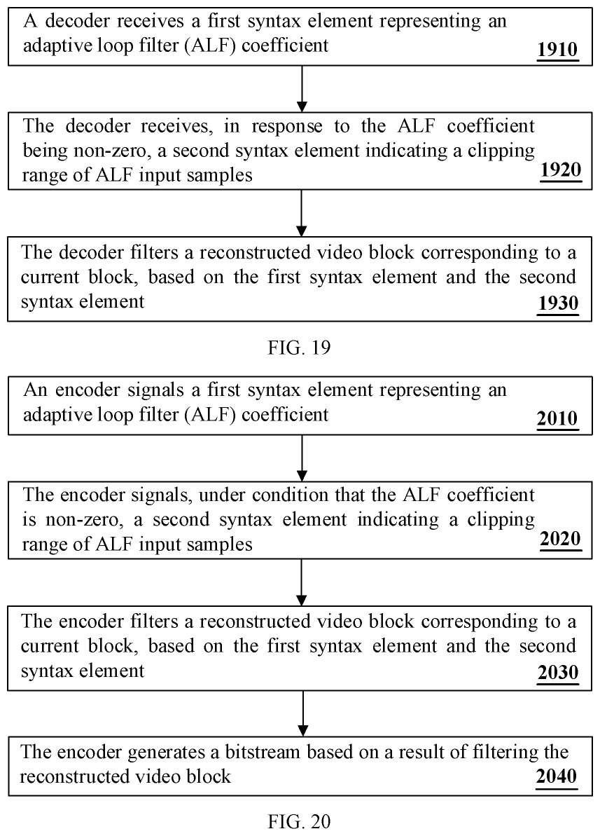

FIG. 19 is a flow chart illustrating a method for video decoding in accordance with some examples of the present disclosure.

In Step 1910, the processor 1620 may, at the side of a decoder, receive a first syntax element representing an adaptive loop filter (ALF) coefficient. In some examples, syntax elements may include motion vectors, intra-mode indicators, partition information, and other such syntax information. In some examples, the ALF coefficient may include a scaling weight to be applied to input values. In some examples, the first syntax element may include an absolute value of the ALF coefficient applied to some color component, such as the Luma component, where the ALF is a Luma ALF. In one or more examples, the first syntax element may include alf_luma_coeff_abs.

In Step 1920, the processor 1620 may, at the side of the decoder and in response to the ALF coefficient being non-zero, receive a second syntax element indicating a clipping range of ALF input samples. In some examples, clipping may be performed in accordance with the section 1.1.1 “Filter Shapes, Linear Filtering and Adaptive Clipping,” and a clipping range may be indicated by a clipping index, for instance as computed in Equation (6). In some examples, the second syntax element may include the clipping index. In some examples, the second syntax element may indicate the clipping range of ALF input samples for an ALF coefficient applied to some color component, such as the Luma component, where the ALF is the Luma ALF. In one or more examples, the second syntax element may include alf_luma_clip_idx. In some examples, in response to the ALF coefficient being zero, the second syntax element is not received.

In Step 1930, the processor 1620 may, at the side of the decoder, filter a reconstructed video block corresponding to a current block, based on the first syntax element and the second syntax element. In one or more examples, to filter the reconstructed video block, the processor 1620 may perform a computation according to or similar to Section “1.2.3 Filtering” above. In one or more than one examples, the ALF coefficients are represented by the first syntax element as described in Step 1910. In one or more examples, when computing the clipped difference in the computation according to or similar to Section 1.2.3, the second syntax element indicating the clipping range as in Step 1920 is used.

In some examples, the processor 1620 may further receive a flag indicating whether an ALF clipping is enabled. In one or more examples, the flag may indicate whether the ALF clipping is enabled in some color component, such as the Luma component, where the ALF is an Luma ALF. In one or several examples, the flag may include alf_luma_clip_flag.

In one or more examples, at Step 1910, the processor 1620 may receive the first syntax element before or after receiving the flag, and the flag indicates that the ALF clipping is enabled.

In one or more examples, in Step 1920, the processor 1620 may receive, in response to the ALF coefficient being non-zero and the flag indicating that the ALF clipping is enabled, the second syntax element.

In one or more examples, in response to the ALF coefficient being non-zero, the processor 1620 may further receive, at the side of the decoder, a third syntax element indicating a positive or negative sign of the ALF coefficient. In one or more than one examples, the third syntax element may indicate the positive or negative sign of the ALF coefficient applied to some color component, such as the Luma component, where the ALF is the Luma ALF. In at least one example, the third syntax element refers to alf_luma_coeff_sign.

In one or several examples, the processor 1620 may receive the flag before or after receiving the first and the third syntax elements, and the flag indicates that the ALF clipping is enabled.

In one or several examples, at Step 1920, the processor 1620 may receive, in response to the ALF coefficient being non-zero and the flag indicating that the ALF clipping is enabled, the second syntax element.

In one or a plurality of examples, the processor 1620 may receive the third syntax element indicating a positive or negative sign of the ALF coefficient before or after receiving the second syntax element.

In some examples, the ALF may be one of a Luma ALF, Chroma ALF, or Cross-Component ALF (CCALF). In some examples, the second syntax element may indicate an upper bound of the clipping range of the ALF input samples, and the upper bound of the clipping range of the ALF input samples may be a power of two. In one or more examples, the processor 1620 may, in response to the second syntax element being 0, 1, 2, or 3, set the upper bound of the clipping range of the ALF input samples to 1024, 8, 32, or 128, respectively.

FIG. 20 is a flow chart illustrating a method for video encoding corresponding to the method for video decoding as shown in FIG. 19 in accordance with some examples of the present disclosure.

In Step 2010, the processor 1620 may, at the side of an encoder, signal a first syntax element representing an adaptive loop filter (ALF) coefficient. In some examples, syntax elements may include motion vectors, intra-mode indicators, partition information, and other such syntax information. In some examples, the ALF coefficient may include a scaling weight to be applied to input values. In some examples, the first syntax element may include an absolute value of the ALF coefficient applied to some color component, such as the Luma component, where the ALF is a Luma ALF. In one or more examples, the first syntax element may include alf_luma_coeff_abs.

In Step 2020, the processor 1620 may, at the side of the encoder and under condition that the ALF coefficient is non-zero, signal a second syntax element indicating a clipping range of ALF input samples. In some examples, clipping may be performed in accordance with the section 1.1.1 “Filter Shapes, Linear Filtering and Adaptive Clipping,” and a clipping range may be indicated by a clipping index, for instance as computed in Equation (6). In some examples, the second syntax element may include the clipping index. In some examples, the second syntax element may indicate the clipping range of ALF input samples for an ALF coefficient applied to some color component, such as the Luma component, where the ALF is the Luma ALF. In one or more examples, the second syntax element may include alf_luma_clip_idx. In some examples, under condition that the ALF coefficient is zero, the second syntax element is not signaled.

In Step 2030, the processor 1620 may, at the side of the encoder, filter a reconstructed video block corresponding to a current block, based on the first syntax element and the second syntax element. In one or more examples, to filter the reconstructed video block, the processor 1620 may perform a computation according to or similar to Section “1.2.3 Filtering” above. In one or more than one examples, the ALF coefficients are represented by the first syntax element as described in Step 2010. In one or more examples, when computing the clipped difference in the computation according to or similar to Section 1.2.3, the second syntax element indicating the clipping range as described in Step 2020 is used.

In Step 2040, the processor 1620 may, at the side of the encoder, generate a bitstream based on a result of filtering the reconstructed video block. In some examples, the result of filtering the reconstructed video block may be obtained by a computation according to or similar to Section “1.2.3 Filtering” above. In one or more examples, the result of filtering the reconstructed video block may include a filtered sample derived following a computation in Section “1.2.3 Filtering.” In one or several examples, the result of filtering the reconstructed video block may include the filtered sample \tilde{R}(x,y) as computed in Equation (13) of Section “1.2.3 Filtering.” In some examples, the bitstream may represent video blocks of an encoded video frame and associated syntax elements. In some examples, the bitstream may be transmitted to a decoder for decoding using methods disclosed above, for example a method in accordance with FIG. 19.

In some examples, the processor 1620 may further signal a flag indicating whether an ALF clipping is enabled. In one or more examples, the flag may indicate whether the ALF clipping is enabled in some color component, such as the Luma component, where the ALF is an Luma ALF. In one or several examples, the flag may be alf_luma_clip_flag.

In one or more examples, at Step 2010, the processor 1620 may signal the first syntax element before or after signaling the flag, and the flag indicates that the ALF clipping is enabled.

In one or more examples, in Step 2020, the processor 1620 may signal, under the condition that the ALF coefficient is non-zero and the flag indicates that the ALF clipping is enabled, the second syntax element.

In one or more examples, under the condition that the ALF coefficient is non-zero, the processor 1620 may further signal, at the side of the encoder, a third syntax element indicating a positive or negative sign of the ALF coefficient. In one or more than one examples, the third syntax element may indicate the positive or negative sign of the ALF coefficient applied to some color component, such as the Luma component, where the ALF is the Luma ALF. In at least one example, the third syntax element refers to alf_luma_coeff_sign.

In one or several examples, the processor 1620 may signal the flag before or after signaling the first and the third syntax elements, and the flag indicates that the ALF clipping is enabled.

In one or several examples, at Step 2020, the processor 1620 may signal, under the condition that the ALF coefficient is non-zero and the flag indicates that the ALF clipping is enabled, the second syntax element.

In one or a plurality of examples, the processor 1620 may signal the third syntax element indicating a positive or negative sign of the ALF coefficient before or after signaling the second syntax element.

In some examples, the ALF may be one of a Luma ALF, Chroma ALF, or Cross-Component ALF (CCALF). In some examples, the second syntax element may indicate an upper bound of the clipping range of the ALF input samples, and the upper bound of the clipping range of the ALF input samples may be a power of two. In one or more examples, the processor 1620 may, under condition that the second syntax element is 0, 1, 2, or 3, set the upper bound of the clipping range of the ALF input samples to 1024, 8, 32, or 128, respectively.

In some examples, there is provided an apparatus for video coding. The apparatus includes a processor 1620 and a memory 1640 configured to store instructions executable by the processor; where the processor, upon execution of the instructions, is configured to perform any method as illustrated in FIGS. 19-20.

In an embodiment, there is also provided a non-transitory computer-readable storage medium comprising a plurality of programs, for example, in the memory 1630, executable by the processor 1620 in the computing environment 1610, for performing the above-described methods and/or storing a bitstream generated by the encoding method described above or a bitstream to be decoded by the decoding method described above. In one example, the plurality of programs may be executed by the processor 1620 in the computing environment 1610 to receive (for example, from the video encoder 20 in FIG. 2) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, there is also provided a computing device comprising one or more processors (for example, the processor 1620); and the non-transitory computer-readable storage medium or the memory 1630 having stored therein a plurality of programs executable by the one or more processors, where the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1630, executable by the processor 1620 in the computing environment 1610, for performing the above-described methods. For example, the computer program product may include the non-transitory computer-readable storage medium.

In an embodiment, the computing environment 1610 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a non-transitory computer-readable storage medium or a digital storage medium, where the bitstream includes encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
receiving, by a decoder, a first syntax element representing an adaptive loop filter (ALF) coefficient;
receiving, by the decoder and in response to the ALF coefficient being non-zero, a second syntax element indicating a clipping range of ALF input samples; and
filtering, by the decoder, a reconstructed video block corresponding to a current block, based on the first syntax element and the second syntax element.

2. The method of claim 1, further comprising:
receiving a flag indicating whether an ALF clipping is enabled.

3. The method of claim 2, wherein receiving, in response to the ALF coefficient being non-zero, the second syntax element comprises:
receiving, in response to the ALF coefficient being non-zero and the flag indicating that the ALF clipping is enabled, the second syntax element.

4. The method of claim 2, wherein in response to the ALF coefficient being non-zero, the method further comprises:
receiving, by the decoder, a third syntax element indicating a positive or negative sign of the ALF coefficient.

5. The method of claim 4, wherein receiving, in response to the ALF coefficient being non-zero, the second syntax element comprises:
receiving, in response to the ALF coefficient being non-zero and the flag indicating that the ALF clipping is enabled, the second syntax element.

6. The method of claim 1, wherein the ALF is one of a Luma ALF, a Chroma ALF, or a Cross-Component ALF (CCALF).

7. The method of claim 1, wherein the second syntax element indicates an upper bound of the clipping range of the ALF input samples, and the upper bound of the clipping range of the ALF input samples is a power of two.

8. The method of claim 7, further comprising:
in response to the second syntax element being 0, 1, 2, or 3, setting the upper bound of the clipping range of the ALF input samples to 1024, 8, 32, or 128, respectively.

9. The method of claim 1, wherein a chroma format of the current block is 4:0:0, 4:2:0, 4:2:2 or 4:4:4.

10. A method for video encoding, comprising:
signaling, by an encoder, a first syntax element representing an adaptive loop filter (ALF) coefficient;
signaling, by the encoder and under condition that the ALF coefficient is non-zero, a second syntax element indicating a clipping range of ALF input samples;
filtering, by the encoder, a reconstructed video block corresponding to a current block, based on the first syntax element and the second syntax element; and
generating, by the encoder, a bitstream based on a result of filtering the reconstructed video block.

11. The method of claim 10, further comprising:
signaling a flag indicating whether an ALF clipping is enabled.

12. The method of claim 11, wherein signaling, under the condition that the ALF coefficient is non-zero, the second syntax element comprises:
signaling, under the condition that the ALF coefficient is non-zero and the flag indicates that the ALF clipping is enabled, the second syntax element.

13. The method of claim 11, wherein under the condition that the ALF coefficient is non-zero, the method further comprises:
signaling, by the encoder, a third syntax element indicating a positive or negative sign of the ALF coefficient.

14. The method of claim 13, wherein signaling, under the condition that the ALF coefficient is non-zero, the second syntax element comprises:
signaling, under the condition that the ALF coefficient is non-zero and the flag indicates that the ALF clipping is enabled, the second syntax element.

15. The method of claim 10, wherein a chroma format of the current block is 4:0:0, 4:2:0, 4:2:2 or 4:4:4.

16. An apparatus for video coding, comprising:
one or more processors; and
a memory coupled to the one or more processors and configured to store instructions executable by the one or more processors,
wherein the one or more processors, upon execution of the instructions, are configured to perform a method for video decoding or a method for video encoding,
wherein the method for video decoding comprises:
receiving, by a decoder, a first syntax element representing an adaptive loop filter (ALF) coefficient;
receiving, by the decoder and in response to the ALF coefficient being non-zero, a second syntax element indicating a clipping range of ALF input samples; and
filtering, by the decoder, a reconstructed video block corresponding to a current block, based on the first syntax element and the second syntax element,
wherein the method for video encoding comprises:
signaling, by an encoder, a first syntax element representing an adaptive loop filter (ALF) coefficient;
signaling, by the encoder and under condition that the ALF coefficient is non-zero, a second syntax element indicating a clipping range of ALF input samples;
filtering, by the encoder, a reconstructed video block corresponding to a current block, based on the first syntax element and the second syntax element; and
generating, by the encoder, a bitstream based on a result of filtering the reconstructed video block.

17. A non-transitory computer-readable storage medium storing a bitstream generated by the method in claim 10.

18. The non-transitory computer-readable storage medium of claim 17, wherein a chroma format of the current block is 4:0:0, 4:2:0, 4:2:2 or 4:4:4.

19. A method for storing a bitstream, comprising:
performing the method claim 10 to generate a bitstream; and
storing the bitstream.

20. The method of claim 19, wherein a chroma format of the current block is 4:0:0, 4:2:0, 4:2:2 or 4:4:4.
